(19) United States
(12) Patent Application Publication
(10) Pub. No.: US 2006/0202055 A1
(43) Pub. Date: Sep. 14, 2006

(54) Device and method for producing a protective liquid wall

(76) Inventors: Rainer L.M Klopp, Ratingen (DE); Jan G Sprakel, Wermelskirchen (DE); Joachim Ritter, Leverkusen (DE)

Correspondence Address: PROSKAUER ROSE LLP;PATENT DEPARTMENT, 1585 BROADWAY, NEW YORK, NY, 10036-8299, US

(21) Appl. No.: 10/521,143

(22) PCT Filed: Jul. 15, 2003
(86) PCT No.: PCT/EP03/07646

§ 371 Date: Sep. 6, 2005

(30) Foreign Application Priority Data
Jul. 15, 2002 (DE) 102 31 922.7

(51) Int. Cl. B05B 1/28

(52) U.S. Cl. 239/103

(57) ABSTRACT

The invention relates to a device and to a method for producing a protective liquid barrier which prevents gases (G) coming from a structure, such as a machine, a storage unit or a production system (P), from spreading at ground level beyond a particular area in the event of an incident. The device is equipped with nozzles (4) connected to a fluid supply (5) and arranged in the vicinity of at least one lengthwise section of a boundary of the area, which respectively EMIT an upwardly directed liquid jet (W) starting from ground level in the event of the incident, and are positioned at a mutual spacing (A) such that at each position of the lengthwise section an air-gas flow (F, G) starting from the bottom (9) of the area, essentially directed perpendicularly to the bottom (9) and entraining the gas (G) flowing at ground level, is created by the overlap of the liquid jets (W) respectively emitted by the nozzles (4), the nozzles (4) being arranged in a channel (2) formed along the lengthwise section, at a vertical distance (T) from its outlet opening.

Notes:

1/2/2: the hyphens are superfluous

6/1/6: the number in brackets has been ignored, since it is inappropriate at this point of the description.

The invention relates to a device and to a method for producing a protective liquid barrier which prevents gases coming from a structure, such as a machine, a storage unit or a production system, from spreading at ground level beyond a particular area in the event of an incident.

Especially in the large-scale production of industrial gases such as ethylene, propylene or butane, gas vapours may be released in the event of an operational incident. Since these vapours are heavier than air, they accumulate at a high concentration near the ground in the vicinity of the production system affected by the operational incident. Air movements and volumes of gas flowing behind then lead to a ground-level gas flow, via which the gases may also reach regions where the gas could ignite or living beings could be endangered because the air has been displaced. The gases spreading at ground level may also be highly toxic and represent a great risk to the living beings inhabiting the vicinity of the object at risk. For this reason, it is necessary to ensure that the spreading of gases spreading at ground level is restricted to a strictly limited particular region in the event of an incident.

In practice, attempts have been made to satisfy this requirement by using protective apparatus which comprises a high wall around the area to be isolated. On the wall, there are nozzles which emit a hot jet of steam directed vertically upwards in the event of an incident. This forms a barrier consisting of steam and bricks, by which the stagnant gas vapours are taken in and mixed with the ambient air so that they enter the region on the other side of the wall at a safe concentration. A problem with this, however, is that the effect and availability of the known protective apparatus is unsatisfactory. Often, for instance, the necessary hot steam cannot be provided within the short reaction time needed for reliable protection, and in sufficient quantities. Furthermore, the hot steam represents a risk for the emergency services working in the vicinity of the system affected by the incident, and their mobility is also restricted by the wall.

Apparatus similar to the aforementioned protective apparatus is known from the field of firefighting. Such protective liquid barriers, also referred to as “hydro-shields”, “water barriers” or “water shields” are used to protect structures or equipment against flames, smoke, heat radiation, combustion gases, dust and toxic clouds of gases and vapour emissions during extinguishing operations. Individually operated flat-jet extinguishing nozzles aimed at the source of danger are used for this. These nozzles emit a flat jet, which spreads laterally in the shape of a fan starting from the nozzle opening and is thin compared with its width. Depending on the nozzle type in question, and the power of the available pump unit, projection widths of up to 30 m and projection heights of up to 10 metres can be achieved with such nozzles. Pressures of from 5 to 7 bar with an extinguishing water throughput of 800 to 1800 litres/minute are typically needed for this. These large volumes of water entail significant problems of disposal, and frequently cause water damage which far exceeds the actual fire damage. It has also been found that the apparatus known from fire protection cannot produce water barriers which permit isolation of the wider environment of a conflagration against harmful gases in a sufficiently reliable way.

Besides the aforementioned prior art, EP 0 335 746 A2 discloses a device for producing a protective liquid barrier which prevents ground-level spreading of gases coming from a chemical production system beyond a particular area in the event of an incident. The known device has nozzles connected to a fluid supply and arranged in the vicinity of at least one lengthwise section of a boundary of the area. A plurality of these nozzles respectively surround drum-shaped nozzle bodies measuring up to 18 metres in height, which are curved outwards and are open at the top. In the event of an incident, the nozzles respectively emit an upwardly directed liquid jet starting close to the ground. Because of the Coanda effect, these liquid jets runs along the outer wall of the nozzle body assigned to the nozzles in question, so that an upwardly directed concentrated flow of water mist is created. This upwardly directed flow can be reinforced by a combustion which is ignited in the nozzle body and further accelerates the hollow jet flowing out of the nozzle body, owing to the heat given off and the flow of smoke resulting from the combustion. An intensely delivered air-gas-water mist flow starting from the bottom of the area, directed upwards and entraining the gas flowing at ground level, is thus created at each position of the lengthwise section.

Even though it is feasible that the device disclosed by EP 0 335 746 A2 could in principle prevent the spreading of ground-level gases in the event of an operational incident, it is nevertheless found that the known device cannot in practice be used in an operationally reliable way, not least because of its overall size and the nozzles which are used.

Another device, which is mobile, intended to prevent the spreading of ground-level gases in case of fire is disclosed by DE 199 60 165 A1. This known device uses a flexible fire service hose in which nozzles for spraying water are fitted. Owing to the use of a flexible hose, the known device can even be employed in highly inaccessible terrain which is technically difficult to manage. The known device does not, however, turn out to be effective enough when stringent requirements are placed on the safety and reliability with which the spreading of hazardous gases flowing at ground level has to be prevented.

Lastly, DE PS 583 297 discloses a device in which a multiplicity of sprinkler nozzles fitted to stands are installed around an object at risk from fire, and these produce a water barrier in order to avert the spreading of gases if a fire breaks out. However, this known device also turns out to be insufficiently reliable and effective in practice.

It is an object of the invention to provide a device and a method employing simple means, by which the ground-level spreading of heavy gases can be averted with high reliability and availability in the event of an incident, without restricting the mobility of the emergency services.

This object is achieved in accordance with the invention, on the one hand, by a device for producing a protective liquid barrier which is equipped with nozzles connected to a fluid supply and arranged in the vicinity of at least one lengthwise section of a boundary of the area, which respectively emit an upwardly directed liquid jet starting from ground level in the event of the incident, and are positioned at a mutual spacing such that at each position of the lengthwise section an air-gas flow starting from the bottom of the area, essentially directed perpendicularly to the bottom and entraining the gas flowing at ground level, is created by the overlap of the liquid jets respectively emitted by the nozzles, the nozzles being arranged in a channel formed along the lengthwise section, at a vertical distance from its outlet opening.

On the other hand, this object is achieved by a method for isolating an area against the spreading of gases coming from a structure, such as a machine, a storage unit or a production system, in which an air-gas flow starting from the bottom of the area, essentially directed perpendicularly to the bottom and entraining upwards the gas flowing at ground level, is produced over at least one lengthwise section of the boundary of the area in the event of an incident by forming an upwardly directed liquid barrier starting from ground level from liquid jets, the liquid jets being produced by nozzles which are arranged in a channel, at a vertical distance from the outlet opening of the channel.

The device in accordance with the invention and the method in accordance with the invention securely prevent gases coming from a structure, such as a machine, a storage unit or a production system, from spreading at ground level beyond a particular area by producing an impenetrably sealed liquid barrier for the heavy gases, formed by individual liquid jets, in the event of an incident. The term “liquid jets” is intended here to mean all forms of jets which fulfil the intended purpose, namely to entrain the gases which enter the active region of the jets. The purpose of this is to set up a liquid barrier whose flow causes the liquid being delivered to become intensely mixed with the ambient air and the entrained gas. It is therefore preferable to deliver liquid jets such that they form a strong liquid vortex barrier already at ground level, which leads to a rapid reduction of the gas concentration owing to the intense mixing with the entrained gas.

For practical implementation of the invention, it has been found particularly suitable to use liquid jets which emerge from the nozzles at a high pressure of at least 50 bar, and which form a concentrated jet emerging with a high flow energy and having a fine droplet distribution. Such liquid jets can be produced using flat-jet nozzles which are known per se, when a sufficiently high pressure is applied to them. If such nozzles are used, then they should be aligned so that the flat jet emerging from them in the shape of a fan spreads along the lengthwise section. Water has been found to be a suitable liquid, since large quantities of it are usually available at the structures which are to be equipped with the device in accordance with the invention. The particular advantage of the invention is then that the object affected by the incident can be effectively isolated from the environment with a low water consumption. The use of a device in accordance with the invention or a procedure in accordance with the invention thus requires only a fraction of the liquid volumes which conventionally have to be used for this purpose. The low liquid consumption leads to a greatly reduced burden on the environment of the apparatus to be isolated. Water damage is thus minimised with less technical outlay.

The liquid jet emerging from the nozzles entrains with it the gases present in the vicinity of the nozzle opening, so that a gas-air flow is formed in alignment with the jet direction. A suction region is formed at the same time below and to the side of the nozzle outlet opening, as viewed in the jet direction, where a lower pressure prevails and into which the air taken in from the environment and the gases flow.

Especially if a liquid jet with concentrated and finely divided droplets is being delivered, the gas-air flow does not remain restricted to the immediate proximity of the nozzle outlet, but rather a general gas-air flow is set up at a longer range. This consists partly of a gas-air mixture flowing along with the liquid jet and partly of the gas-air volumes drawn into the suction region. Here, what is essential for the action of the protective device in accordance with the invention is that the mutual spacing of the nozzles should be selected so that owing to this gas-air flow generally being formed, the heavy gases collecting at ground level are transported away even in the regions which are not directly covered by the nozzle jets. With little equipment outlay, this ensures reliable isolation of the heavy gases accumulating over a particular area. The heavy gases are entrained upwards and intensely mixed with the air which is also entrained, before they are released at a great height with a concentration so low that they are safe.

Here, it is essential to the invention that the nozzles should be arranged in a channel so that the liquid jet emitted by each of them emerges from the nozzles at a distance from the opening of the channel. Owing to the arrangement of the outlet openings of the nozzles below the channel opening, the jet already has a larger volume when it emerges from the ground than is the case immediately after the nozzle outlet openings. At the ground, therefore, each liquid jet emitted by the sunken nozzles already covers a larger region of the boundary of the area to be isolated than is the case if the nozzle opening is mounted above the ground or level with the ground. Arranging the nozzles in a channel therefore makes it possible to increase the effectiveness of the liquid barrier produced by a device in accordance with the invention, while also using a smaller number of nozzles. With the arrangement in accordance with the invention, since the nozzles and the liquid jet emerging from each of them are laterally restricted from the surroundings over a particular minimum height by the mutually opposing channel walls, a reduced pressure is then created in the channel which further reinforces the transport of the air/gas mixture entrained by the liquid jets. The reduced pressure created in the channel also draws in heavy gases between the nozzles into the channel, and these are subsequently taken up, mixed and propelled upwards by the liquid jets flowing out.

The structural measures required for practical implementation of the invention only take up little space, so that the emergency services are not impeded in their movement and rescue equipment can be brought into position without hindrance. Here, it is not absolutely necessary for the channel provided in accordance with the invention to be formed as a hole made in the ground or another surface. Instead, the channel may also be produced by using suitable components, for example a U-shaped component section, to form a channel placed on the surface in question. This above-ground design of the channel proves particularly suitable for cases in which effective isolation of an object at risk has to be provided within short setting-up times. It is essential here, however, that the nozzles should always be sunk in the channel at a sufficient depth below the edge of the outlet opening.

A particularly practical configuration of the invention is characterised in that the outlet openings of the nozzles are arranged below the surface of the ground. The concentration of the liquid jets emerging from the channel in the height direction can be optimised in this case if the outlet opening of the channel is delimited by a sharp edge at least on its lengthwise side facing the structure.

The formation of a gas-air flow directed vertically upwards as intended in accordance with the invention can be reinforced if, in addition to the nozzles which emit a liquid jet, further nozzles which emit an upwardly directed gas jet are distributed along the lengthwise section. The additionally provided gas jet reinforces the outflow of the liquid jet, on the one hand, and on the other hand it causes the heavy gas to be diluted particularly rapidly by the ambient air. It is therefore particularly expedient for the further nozzles to be connected to a compressed air supply.

The mixing and dilution of the heavy gas vapours with the ambient air may also be reinforced if there are air delivery instruments on the side of the nozzles facing away from the structure, which provide directed delivery of the ambient air on this side into the air-gas flow produced by the nozzles. On the one hand, the volume of air taken in by the liquid jet can be optimised in this way. On the other hand, the air delivery instruments can be aligned so that the incoming air reinforces the concentrated orientation of the liquid jet and the gas-air flow due to it. In particular, this turns out to be very favourable when the nozzles are arranged below ground level. In this case, the air delivery instruments can be designed as air feed channels leading from the surface of the ground into the vicinity of the nozzles.

The invention will be explained in more detail below with reference to a drawing which represents an embodiment, in which:

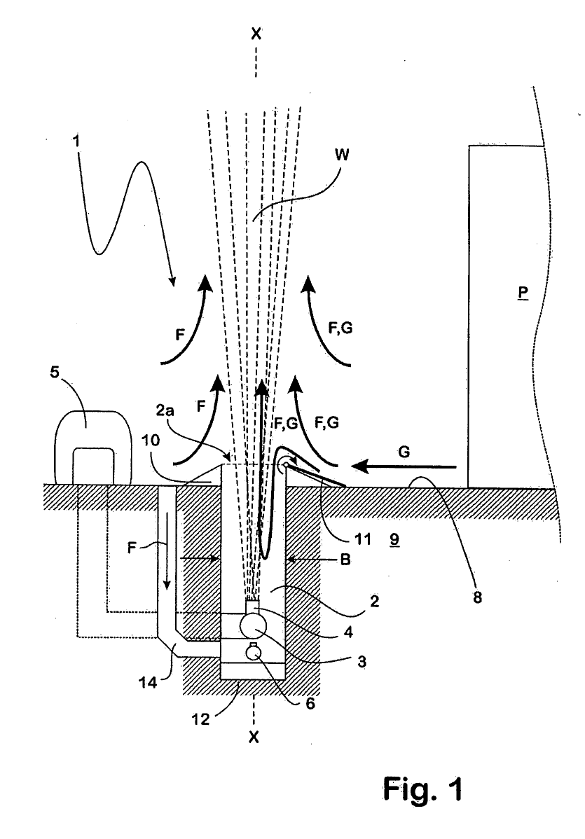

FIG. 1 schematically shows a section through a device system for producing a protective liquid barrier, arranged in the vicinity of an industrial gas production;

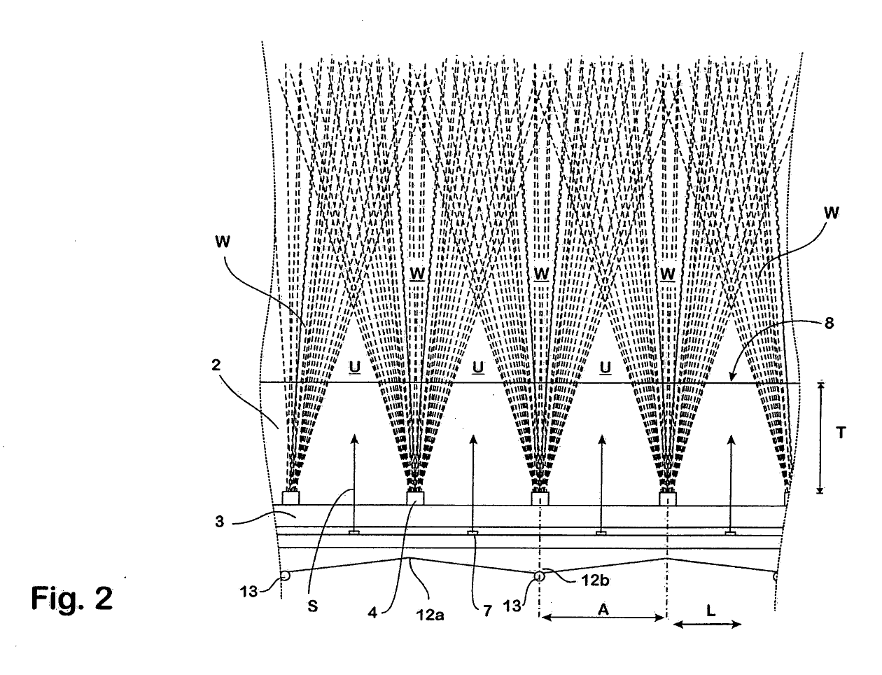

FIG. 2 shows the device according to FIG. 1 in a section on the section line X-X as indicated in FIG. 1.

The device 1 is used to protect a system P in which industrial gases heavier than air are produced, or are used for the production of other products.

In order to produce a protective liquid barrier, the device 1 comprises a supply line 3 which is arranged close to the bottom of an open-topped channel 2 surrounding the system P, at a distance from it, and on the upper side of which flat-jet nozzles 4 are fitted at regular intervals A. The supply line 3 is connected to a pressure supply 5 which, in the event of an operational incident of the system P leading to the emission of gas G, delivers highly pressurised water into the supply line 3. The pressure supply 5 is in this case activated by an alarm instrument (not shown) which automatically emits a control signal for starting the pressure supply 5 if gas is released.

The flat-jet nozzles 4 respectively emit a finely sprayed water jet W which is concentrated into a small thickness as viewed in the direction of the width B of the channel 2, whereas it fans out broadly as viewed in the lengthwise direction L of the channel 2. The spacing A of the flat-jet nozzles 4 and the depth T, at which the openings of the flat-jet nozzles 4 are arranged below the surface 8 of the ground 9, are in this case matched to each other so that the water jets W emitted by them overlap at a short distance above the surface 8. In this way, between any two neighbouring water jets W there is only ever a narrowly delimited space of small volume not directly covered by a water jet W.

A compressed air line 6 which is connected to a compressed air source (not shown) is arranged below the supply line 3. The compressed air line 6 supplies compressed air nozzles 7, one of which is centrally arranged respectively between two of the flat-jet nozzles 4 in the longitudinal direction L of the channel 2. The compressed air nozzles 7 emit a compressed air jet S, which is likewise directed upwards in the direction of the opening of the channel 2.

The opening 2a of the channel is delimited on its lengthwise sides by edge bodies 10, shaped triangularly in cross section, which have a running face rising from the surface 8 of the ground 9. With the edge of their high lengthwise side facing the channel 2, the edge bodies 10 form a tear-off edge for heavy gases G flowing in the direction of the channel 2 over the ground 9 from the one side, and for air F flowing into the channel 2 from the other side. At the same time, the edge bodies 10 make it easy for vehicles 2 to drive over the channel 2.

Flaps 11 are provided in order to prevent dirt from entering the device 1 when it is off. The flaps 11 are held articulated to the upper edge of the edge bodies 10 belonging to one side of the channel 2. When the device is off, they rest on the edge of the respectively opposing edge bodies 10. Their weight and their tilting mobility are in this case matched to the energy of the water jets W so that when pressure is applied to the flat-jet nozzles 4 for the first time they are tilted away, from the water jets W which emerge so as to release the channel opening. FIG. 1 represents the position of the flaps 11 in dashes when the device is off, and by continuous lines during operation of the device 1.

As viewed in the lengthwise direction L, the bottom 12 of the channel 2 has regularly alternating ridges 12a and depressions 12b. Drainage tubes 13 which discharge the water collecting in the channel 2 into a drain (not shown) are arranged at the lowermost point of the depressions.

Air feed channels 14, which start from the surface 8 of the ground 9 and discharge into one lengthwise wall of the channel 2, close to the channel bottom 12, are formed in the ground 9 on the side of the channel 2 facing away from the system P. Air from the side facing away from the system P can flow into the channel 2 through the air feed channels 14.

In practice, for example, the depth T could be from 50 cm to 100 cm and the width B of the channel 2 could be about 10 cm to 30 cm. The flat-jet nozzles 4 may have a typical aperture angle of 30° and diameters of from 1.5 mm to 2.5 mm. The spacing A between them may be between 50 cm and 130 cm, depending on the selected depth T. The high pressure provided by the pressure supply 5 may be in the range of from 100 bar to 300 bar. If these examples of design and operating parameters are complied with, then a highly effective water barrier can be produced over a channel length of about 200 m with a low water consumption, which is of the order of a few hundreds of cbm/h.

If gases G are released in the event of an operational incident of the system P, then the pressure supply 5 is activated and water is applied to the flat-jet nozzles 4, so that the water jets W emerge from them and the hitherto closed flaps 11 are tilted aside. A water barrier, which is formed by overlapping water jets W of small thickness but large width, is thus formed after a short start-up time.

The water jets W here consist of finely sprayed droplets with a high kinetic energy, which entrain the air volumes and gases next to the water jets W. An upwardly directed flow F, G formed by a mixture of air and gas G is thus set up on the side next to the system P, whereas a pure air flow F is formed on the side away from the system P. The effect of these flows is that there is a reduced pressure in the vicinity of the channel 2 compared with the environment further away, so that air and gas G flowing at ground level are drawn into the channel 2 through the air feed channels 14. This air also mixes with any gas G which is drawn into the channel 2 owing to the reduced pressure in the vicinity of the free spaces U between the water jets W, which are not directly covered by the water jets W, because of the reduced pressure prevailing there in the water jets W flowing out with a high kinetic energy and entraining the ambient air. The mixing of air and gas G is reinforced by the upwardly directed compressed air jets S emerging from the nozzles 7. The overall effect achieved is that the heavy gases G from the surface 8 of the ground 9 are sent to a great height and mixed with air along the way so much that there is a safe, non-critical concentration above the range of the water jets W.

The range, the intensity of the mixing and therefore the impenetrability of the water barrier formed by the water jets W for heavy gases G can be increased by raising the operating pressures of the pressure supply 5. With the prior art at present, for instance, it is already possible to achieve peak pressures of several thousand bars for a sufficient operating time.

The invention therefore provides a device which can produce a gas-isolating and mixing protective barrier of sufficient height within extremely short reaction times. This protective barrier can be readily sustained for an operating time which is necessary in order to seal the gas leak in question. The water volumes needed for this are small, so that the risk of water damage is minimised. Both when it is off and when it is operating, moreover, the device in accordance with the invention does not occupy space which restricts the mobility of the emergency services and maintenance staff or equipment.

1. A device for producing a protective liquid barrier which prevents gases coming from a structure, such as a machine, a storage unit or a production system, from spreading at ground level beyond a particular area in the event of an incident,
having nozzles connected to a fluid supply and arranged in the vicinity of at least one lengthwise section of a boundary of the area,
which respectively emit an upwardly directed liquid jet starting from ground level in the event of the incident, and
are positioned at a mutual spacing such that at each position of the lengthwise section an air-gas flow starting from the bottom of the area, essentially directed perpendicularly to the bottom and entraining the gas flowing at ground level, is created by the overlap of the liquid jets respectively emitted by the nozzles,
the nozzles being arranged in a channel formed along the lengthwise section, at a vertical distance from its outlet opening.

2. The device according to claim 1,
wherein
the nozzles emit a liquid spray jet.

3. The device according to claim 1,
wherein
the nozzles emit a flat jet spreading in the shape of a fan along the lengthwise section.

4. The device according to claim 1,
wherein
the fluid supply applies a high pressure to the fluid emerging from the nozzles.

5. The device according to claim 1,
wherein
the outlet openings of the nozzles are arranged below the surface of the ground.

6. The device according to claim 5,
wherein
the outlet opening of the channel is delimited by a sharp edge at least on its lengthwise side facing the structure.

7. The device according to claim 1,
wherein
in addition to the nozzles which emit a liquid jet, further nozzles which emit an upwardly directed gas are distributed along the lengthwise section.

8. The device according to claim 7,
wherein
the further nozzles are connected to a compressed air supply.

9. The device according to claim 1,
wherein
on the side of the nozzles facing away from the structures, there are air delivery instruments which provide directed delivery of the ambient air on this side into the air-gas flow produced by the nozzles.

10. The device according to claim 9,
wherein
the air delivery instruments are designed as air feed channels leading from the surface of the ground into the vicinity of the nozzles.

11. The device according to claim 1,
wherein
the fluid is water.

12. A method for isolating an area against the spreading of gases coming from a structure, such as a machine, a storage unit or a production system, in which an air-gas flow starting form the bottom of the area, essentially directed perpendicularly to the bottom and entraining upwards the gas flowing at ground level, is produced at least one lengthwise section of the boundary of the area in the event of an incident by forming an upwardly directed liquid barrier starting from ground level from liquid jets, the liquid jets being produced by nozzles which are arranged in a channel, at a vertical distance from the outlet opening of the channel.

13. A method according to claim 12,
wherein
a plurality of nozzles are positioned at a mutual spacing along the lengthwise section such that at each position of the lengthwise section air-gas flow entraining the gas flowing at ground level is created by the overlap of the liquid jets respectively emitted by the nozzles.

14. A method according claim 12
wherein
a pressurised fluid under high pressure is applied to the nozzles.
